(19) United States
(12) Patent Application Publication
(10) Pub. No.: US 2023/0068970 A1
(43) Pub. Date: Mar. 2, 2023

(54) Position Detection Device

(71) Applicant: Rohm Co., Ltd., Kyoto (JP)

(72) Inventor: Shinichi Otsuka, KYOTO (JP)

(21) Appl. No.: 17/890,605

(22) Filed: Aug. 18, 2022

(30) Foreign Application Priority Data
Aug. 27, 2021 (JP) 2021138794

(51) Int. Cl. G01B 11/00; G02B 6/42; B25J 9/16

(52) U.S. Cl. CPC G01B 11/005; G02B 6/4298; B25J 9/1697

(57) ABSTRACT

The present disclosure provides a position detection device. The position detection device includes a movable unit, a light source unit and a color sensor. The movable unit can move along a moving direction and include one or more colored portions. The light source unit irradiates the colored portions with a light. The color sensor receives a reflected light reflected by the colored portions and detecting a color component.

### TECHNICAL FIELD

The present disclosure relates to a position detection device.

### BACKGROUND

A position detection device that detects a rotation position of an object is available in the prior art. For such position detection device, a magnetic sensor or a photointerrupter is often used (refer to, for example, patent documents 1 and 2 for the magnetic sensor and the photointerrupter).

When a magnetic sensor is used, an alternating magnet that magnetizes the magnetic poles (S pole and N pole) is mounted in the rotational direction of a rotatable rotating object, and switching of magnetic poles is detected by the magnetic sensor.

Moreover, when a photointerrupter is used, a light shielding portion and an opening portion are alternately arranged in the rotational direction of a rotating object, and the rotating object is arranged between a light emitting portion and a light receiving portion in the photointerrupter. Thus, switching between shielding and transmission of light emitted from the light emitting portion is detected by the photointerrupter.

### PRIOR ART DOCUMENT

### Patent Publication

[Patent document 1] Japan Patent Publication No. 2012-191128
[Patent document 2] Japan Patent Publication No. 2020-170802

### SUMMARY OF THE PRESENT DISCLOSURE

### Problems to be Solved by the Present Disclosure

However, in either situation where a magnetic sensor or a photointerrupter is used, in order to detect a rotation position of a rotating object, it is necessary to count, starting from a predetermined initial position of the rotating object, detection results of switching of magnetic poles of the magnetic sensor, or detection results of switching between shielding and transmission of light of the photointerrupter. That is to say, at the time of starting to detect the rotation position, the rotating object needs to be returned to the predetermined initial position.

In view of the situations above, it is an objective of the present disclosure to provide a position detection device capable of more effectively performing position detection of an object.

### Technical Means for Solving the Problem

For example, a position detection device of the present disclosure is configured to include a movable unit movable along a moving direction and including one or more colored portions, a light source unit irradiating the colored portion with a light, and a color sensor receiving a reflected light reflected by the colored portion and detecting a color component.

### Effects of the Present Disclosure

The position detection device according to the present disclosure is capable of more effectively performing position detection of an object.

### BRIEF DESCRIPTION OF THE DRAWINGS

FIG. 1 is a schematic diagram of a configuration of a position detection device according to a first embodiment.

FIG. 2 is a diagram of electrical configurations of a white light emitting diode (LED) and a color sensor in the position detection device shown in FIG. 1.

FIG. 3 is a diagram of a configuration example of a color sensor.

FIG. 4 is a schematic diagram of a configuration of a position detection device according to a second embodiment.

FIG. 5 is a schematic diagram of a configuration of a position detection device according to a third embodiment.

FIG. 6 is a schematic diagram of a configuration of a position detection device according to a fourth embodiment.

FIG. 7 is a schematic diagram of a configuration of a position detection device according to a fifth embodiment.

FIG. 8 is a schematic diagram of a configuration of a position detection device according to a variation example of the fifth embodiment.

FIG. 9 is a schematic diagram of a configuration example of an industrial robot.

FIG. 10 is a schematic diagram of a configuration example of a home machine.

FIG. 11 is a diagram of a configuration example of a position detection device using a magnetic sensor.

FIG. 12 is a diagram of an example of the behavior of a detection signal with respect to switching of magnetic poles.

### DETAILED DESCRIPTION OF THE EMBODIMENTS

Details of the exemplary embodiments of the present disclosure are provided with the accompanying drawings below.

### First Embodiment

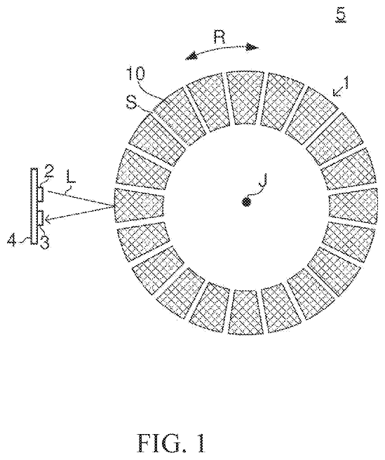

FIG. 1 shows a schematic diagram of a configuration of a position detection device 5 according to a first embodiment. As shown in FIG. 1, the position detection device 5 includes a movable unit 1, a white light emitting diode (LED) 2, a color sensor 3 and a substrate 4.

The movable unit 1 is a rotating object rotatable along a rotational direction R. The rotational direction R is an example of a moving direction.

As shown in FIG. 1, the movable unit 1 includes multiple colored portions 10 (the shaded parts in FIG. 1) arranged along the rotational direction R. The number of the colored portions 10 shown in FIG. 1 is an example. When viewed in a rotational axis direction (a direction perpendicular to the surface of paper) along which a rotational axis J of the movable unit 1 extends, the colored portion 10 has a fan-shaped region that is a part of the radially outer side about the rotational axis J as the center. Moreover, the radial direction is a radial direction with respect to the rotational axis J. That is to say, the colored portion 10 has a region extending in the rotational direction R. The colors are the same (one color) within the region.

The multiple colored portions 10 are set to have different colors from one another. That is to say, the multiple colored portions 10 do not contain the same color. The colored portions 10 are formed, for example, by means of printing.

Moreover, a region S between adjacent two colored portions 10 in the rotational direction R can be set as a region having a color (for example, white) different from any one of the colors of the plurality of colored portions 10, or can be set as a space (a gap). Moreover, the region S may be omitted. Moreover, in the present disclosure (the first embodiment, and the various embodiments), the term “colored portion” is limited to a region of a position detection target, and does not include a region containing the color of a non-position detection target (for example, the region S).

The white LED 2 is a chip LED (a light source unit) that emits a white light. The white light is a light that includes all wavelengths in the visible light region.

The color sensor 3 is a sensor integrated circuit (IC) capable of detecting color components of the light. Specifically speaking, the color components refer to an R component (red component), a G component (green component) and a B component (blue component).

The white LED 2 and the color sensor 3 are mounted on the same substrate 4. The substrate 4 is fixed at a fixing portion that is not shown in the drawings. With the same substrate 4, positioning of the white LED 2 and the color sensor 3 can be easily implemented. Moreover, by arranging the substrate 4 near the colored portions 10, the position detection device 5 can be minimized.

A light L emitted from the white LED 2 directly irradiates the colored portions 10, and reflected light reflected by the colored portions 10 is directly received by the color sensor 3. Moreover, the positions of the white LED 2, the color sensor 3 and the substrate 4 in FIG. 1 relative to the movable unit 1 are depicted for the sake of convenience; in fact, the white LED 2 and the color sensor 3 are arranged oppositely in the rotational axis direction with respect to the colored portions 10. The same arrangement of the white LED 2 and the color sensor 3 located to be exactly facing the fronts of the colored portions applies to the other embodiments in the description below.

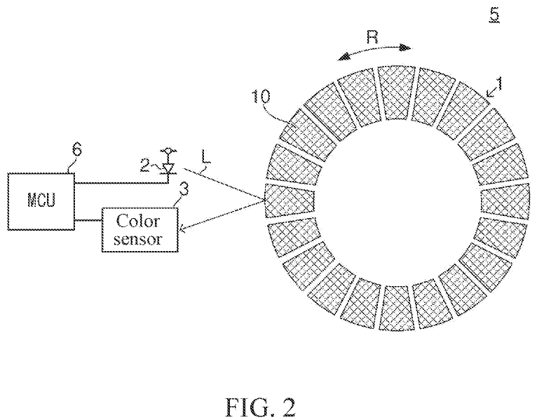

FIG. 2 shows a diagram of related electrical configurations of the white LED 2 and the color sensor 3 in the position detection device 5 shown in FIG. 1. In the configuration shown in FIG. 2, the anode of the white LED 2 is connected to an application terminal of a power supply voltage, and the cathode of the white LED 2 is connected to a micro control unit (MCU) 6. Moreover, the color sensor 3 is connected to the MCU 6.

The white LED 2 is driven by the MCU 6 to emit the light L from the white LED 2. The color sensor 3 outputs a result of color components detected in the received reflected light to the MCU 6.

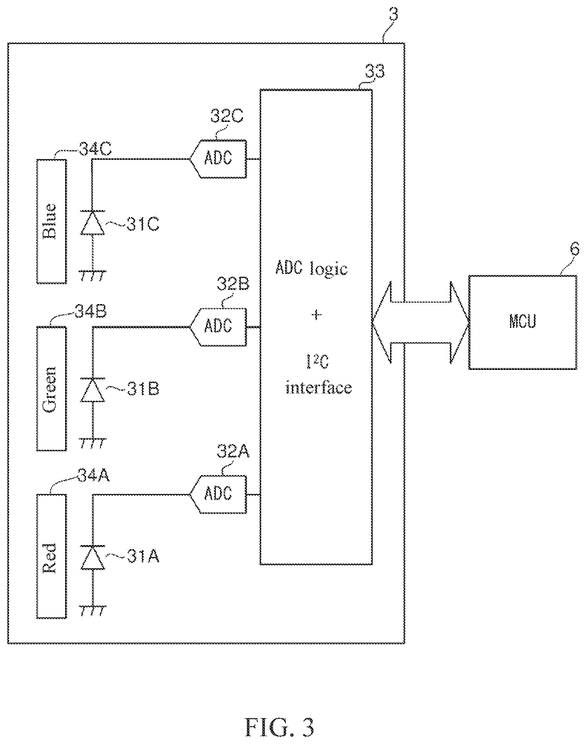

FIG. 3 shows a diagram of a configuration example of the color sensor 3. The color sensor 3 shown in FIG. 3 includes light receiving elements 31A, 31B and 31C, analog-to-digital converters (ADCs) 32A, 32B and 32C, a logic circuit 33, a red light transmission filter 34A, a green light transmission filter 34B and a blue light transmission filter 34C.

The light receiving element 31A generates an analog current signal corresponding to a light amount of a red light entering through the red light transmission filter 34A. That is to say, the light receiving element 31A detects the R component (red component) of an input light.

The light receiving element 31B generates an analog current signal corresponding to a light amount of a green light entering through the green light transmission filter 34B. That is to say, the light receiving element 31B detects the G component (green component) of the input light.

The light receiving element 31C generates an analog current signal corresponding to a light amount of a blue light entering through the blue light transmission filter 34C. That is to say, the light receiving element 31C detects the B component (blue component) of the input light.

The light receiving elements 31A, 31B and 31C may be appropriately implemented by such as photodiodes or phototransistors.

The ADCs 32A, 32B and 32C convert analog current signals from the light receiving elements 31A, 31B and 31C into, for example, 16-bit digital data.

The logic circuit 33 has an ADC logic function (that is, a time-division control function of an ADC), and an Inter-Integrated Circuit (I²C) interface function (that is, a communication function of data signals SDA and logic signals SCL). The logic circuit 33 sends the digital data as detection signals of the R, G and B components output from the ADCs 32A, 32B and 32C to the MCU 6 through I²C communication.

The MCU 6 calculates ratios of the R component, the G component and the B component according to the digital data input from the color sensor 3. Since the colors of the colored portions 10 correspond to the rotation position of the movable unit 1, the MCU 6 is capable of detecting the rotation position by the calculated ratios of the R, G and B components. That is to say, the MCU 6 functions as a position detection unit that detects the rotation position.

FIG. 11 shows a diagram of a configuration example of a position detection device using a magnetic sensor in comparison with the position detection device 5 of the present disclosure.

A position detection device 105 shown in FIG. 11 includes a movable unit 100 and a magnetic sensor 101. The movable unit 100 is a rotating object rotatable along a rotational direction R, and includes an alternating magnet 100A. The alternating magnet 100A is a magnet that alternately magnetizes the S pole and the N pole along the rotational direction R.

The magnetic sensor 101 is a Hall sensor, and is a sensor that uses the Hall effect to convert the magnetism generated by the alternating magnet 100A into an electrical signal, that is, a detection signal Sₒᵤₜ, and outputs the electrical signal. The detection signal Sₒᵤₜ output from the magnetic sensor 101 is input to an MCU 102. The magnetic sensor 101 is fixed at a fixing portion that is not shown in the drawings.

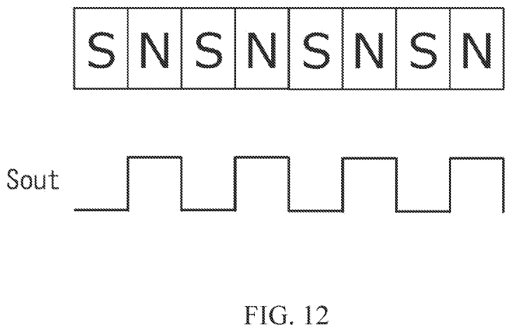

As shown in FIG. 12, while the movable unit 100 rotates, the detection signal Sₒᵤₜ changes to a low level or a high level according to the magnetic pole of the alternating magnet 100A. The switching of the magnetic pole is detected by the switching of the level of the detection signal Sₒᵤₜ.

To detect the rotation position by the position detection device 105, starting from a state in which the movable unit 100 is returned to a predetermined initial position, the MCU 102 counts the switching of the level of the detection signal Sₒᵤₜ, that is, the switching of the magnetic pole, accordingly detecting the rotation position of the movable unit 100. Thus, in the position detection device 105 using the magnetic sensor 101, it is necessary to return the movable unit 100 to the predetermined initial position, and to count the detection signal Sₒᵤₜ.

In contrast, because the position detection device 5 of the present disclosure is in a configuration that detects the rotation position by detecting the color of the colored portions 10, it is not necessary to return the movable unit 1 to the predetermined initial position or count the signal, and the rotation position of the movable unit 1, including the initial position at the time when the detection of the rotation position starts, can be detected. Moreover, in the position detection device 105 that uses the magnetic sensor 101, it is not easy to detect the rotation position if the rotation direction R changes halfway. However, the position detection device 5 of the present disclosure, in the above case, can detect the rotation position regardless of the rotational direction R.

Moreover, in the position detection device 105 that uses the magnetic sensor 101, in order to enhance the resolution of rotation position detection, the number of magnetization of the alternating magnet 100A needs to be increased, causing an issue of increased costs of the alternating magnet 100A. In contrast, for the position detection device 5 of the present disclosure, in order to enhance the resolution of rotation position detection, only the number of the colored portions 10 is increased, for example, by means of printing, and thus increased costs can be inhibited.

Moreover, in the position detection device 5 of the present disclosure, since multiple color portions 10 in the same color are used in the region of one colored portion 10, discrete rotation position detection can be performed.

### 2. Second Embodiment

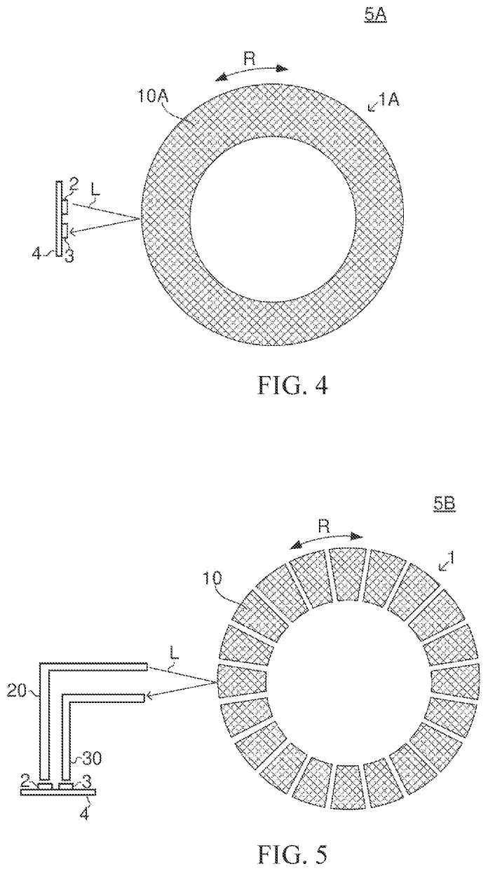

FIG. 4 shows a schematic diagram of a configuration of a position detection device 5A according to a second embodiment. The position detection device 5A differs from the configuration of the position detection device 5 (FIG. 1) of the first embodiment in respect of the structure of a movable unit 1A.

The movable unit 1A shown in FIG. 4 has a colored portion 10A. The colored portion 10A has a region (an annular region) that extends throughout the entire circumference along the rotational direction R. The region of the colored portion 10A has a gradation in which a color changes continuously along the rotational direction R.

Accordingly, the colored portion 10A is irradiated by the light L from the white LED 2, the reflected light from the colored portion 10A is received by the color sensor 3, and the color sensor 3 detects the color components. Accordingly, continuous rotation position detection of the movable unit 1A can then be performed.

### 3. Third Embodiment

FIG. 5 shows a schematic diagram of a configuration of a position detection device 5B according to a third embodiment. The position detection device 5B differs from the configuration of the position detection device 5 (FIG. 1) of the first embodiment in respect of including light guides 20 and 30.

The light guides 20 and 30 are formed by, for example, optical fiber bundles. The light guide 20 receives and guides the light emitted from the white LED 2, and emits the light toward the colored portions 10. The light guide 30 receives and guides the reflected light reflected by the colored portions 10, and emits the light toward the color sensor 3.

According to the configuration above, even when the white LED 2 and the color sensor 3 cannot be arranged near the movable unit 1 due to design limitations, the colored portions 10 can be irradiated with the light and the reflected light can be detected. Moreover, the colored portions of this embodiment can also be configured as the colored portion 10A of the second embodiment.

### 4. Fourth Embodiment

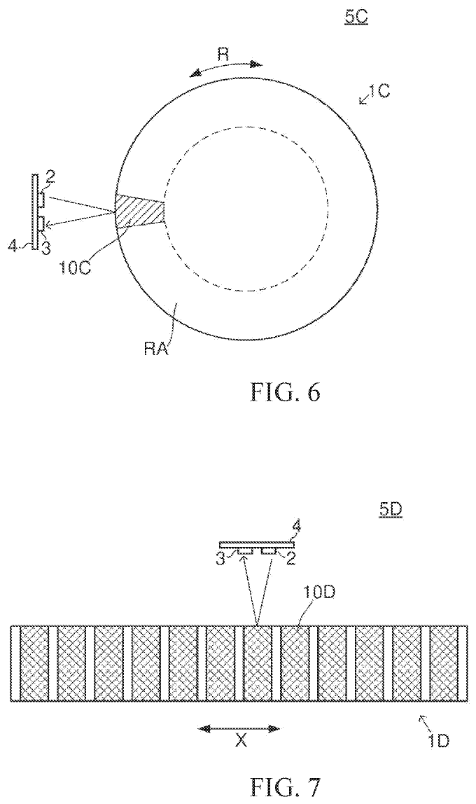

FIG. 6 shows a schematic diagram of a configuration of a position detection device 5C according to a fourth embodiment. The position detection device 5C differs from the configuration of the position detection device 5 (FIG. 1) of the first embodiment in respect of the structure of a movable unit 1C.

As shown in FIG. 6, the movable unit 1C includes a single colored portion 10C. Within the region of the colored portion 10C, colors are the same (one color). Moreover, within a region throughout the entire circumference along the rotational direction R, a region RA outside the colored portion 10C can also be a region in a color (for example, white) different from the colored portion 10C, or can be a space.

According to this configuration, the light emitted from the white LED 2 and reflected by the colored portion 10C is received by the color sensor 3, and color components are detected, accordingly detecting the movable unit 1C located at a predetermined rotation position.

### 5. Fifth Embodiment

FIG. 7 shows a schematic diagram of a configuration of a position detection device 5D according to a fifth embodiment. The position detection device 5D differs from the configuration of the position detection device 5 (FIG. 1) of the first embodiment in respect of the structure of a movable unit 1D.

The movable unit 1D is movable linearly along a moving direction X. The moving direction X is an example of a moving direction. The movable unit 1D includes multiple colored portions 10D arranged along the moving direction X. Within the region of one colored portion 10D, colors are the same (one color). The multiple colored portions 10D have different colors from one another. Moreover, in FIG. 7, although a region is provided between adjacent colored portions 10D, this region may be omitted.

According to this configuration, the light emitted from the white LED 2 and reflected by the colored portions 10D is received by the color sensor 3, and color components are also detected by the color sensor 3, accordingly detecting a movement position of the movable unit 1D moving linearly.

Moreover, the colored portion 10D can also be configured as the colored portion having a gradation same as that of the second embodiment. In this case, the colored portion has a color that continuously changes along the moving direction X.

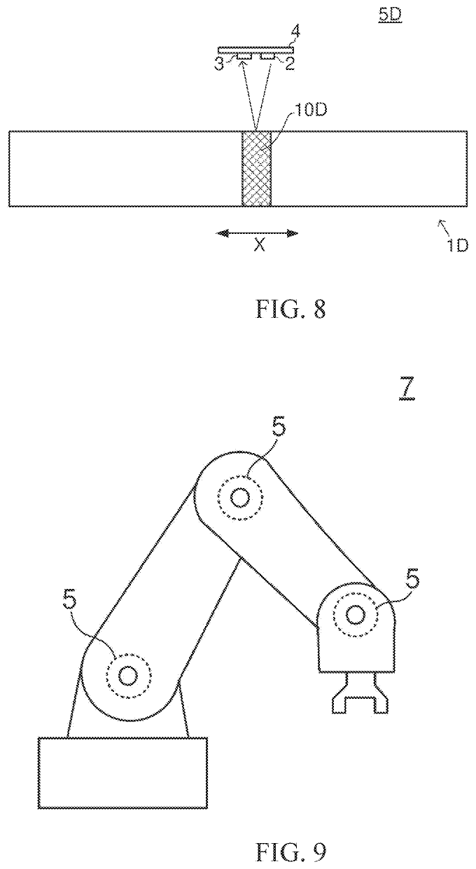

Alternatively, as shown in FIG. 8, the colored ‘portion 10D can also be configured as the single colored portion same as that of the fourth embodiment. In this case, the linearly moving movable unit 1D at a predetermined movement position can be detected.

### 6. Application Example of Position Detection Device

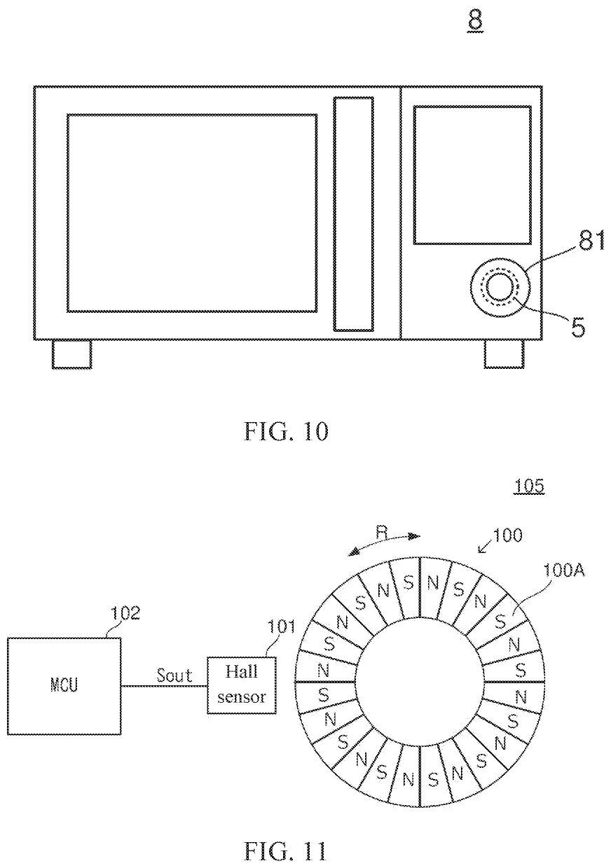

The position detection devices of the embodiments described above can be appropriately mounted on various devices. An example of appropriate application targets is described below with reference to FIGS. 9 and 10. In FIGS. 9 and 10, for illustration purposes, the position detection device is set to be the position detection device 5; however, the position detection device mounted is not limited to being the position detection device 5 of the first embodiment.

FIG. 9 shows a schematic diagram of a configuration example of an industrial robot 7 mounted with the position detection device 5. The industrial robot 7 shown in FIG. 9 has a multi-joint structure, and is driven by a motor that is not shown in the drawing. As shown in FIG. 9, the position detection device 5 can be mounted on various joint portions of the industrial robot 7. Accordingly, angles of the various joint portions can be detected. In particular, it is not necessary to return the angular positions of the various joint portions to predetermined initial positions before starting detection of the angles of the various joint portions.

FIG. 10 shows a schematic diagram of a configuration example of a home machine 8 mounted with the position detection device 5. Moreover, although the home machine 8 shown in FIG. 10 is exemplified by a microwave, the home machine 8 may be various home machines such as audio machines and washing machines.

As shown in FIG. 10, the home machine 8 has a dial 81. The movable unit 1 of the position detection device 5 is fixed at a component different from the movable unit 1, that is, the dial 81. Accordingly, the movable unit 1 rotates along with the rotation of the dial 81. Hence, the rotation position of the dial 81 can be detected. In particular, it is not necessary to return the dial 81 to a predetermined initial position before starting detection of the rotation position of the dial 81. Moreover, the movable unit 1 can also be a component identical to the dial 81.

### 7. Other

Embodiments are as described above; however, various modifications may be made to the embodiments without departing from the scope of the subject matter of the present disclosure. Moreover, the embodiments may also be implemented in combination without involving any contradiction.

### 8. Notes

As described above, for example, a position detection device (5) according to an aspect of the present disclosure is configured to include: a movable unit (1), movable along a moving direction (R) and including one or more colored portions (10); a light source unit (2), irradiating the colored portion with a light; and a color sensor (3), receiving a reflected light reflected by the colored portion and detecting a color component (a first configuration, FIG. 1).

Moreover, the first configuration may also be configured as, wherein the movable unit (1) includes the plurality of colored portions (10) arranged along the moving direction (R), the plurality of colored portions have different colors from each other, and in a region of one of the plurality of colored portions, the colors are the same (a second configuration, FIG. 1).

Moreover, the second configuration may also be configured as, wherein a region (S) between adjacent two of the plurality of colored portions (10) has a color different from any one of the colors of the plurality of colored portions (10), or has a space (a third configuration, FIG. 1).

Moreover, the first configuration may also be configured as, wherein the colored portion (10) has a gradation in which a color changes continuously along the moving direction (R) (a fourth configuration, FIG. 4).

Moreover, the first configuration may also be configured as, wherein the movable unit (1C) includes a single colored portion (10), and in a region of the colored portion (10), colors are the same (a fifth configuration, FIG. 6).

Moreover, the configuration of any one of the first to fifth technical solutions may also be configured as, including: a first light guide (20), receiving and guiding the light emitted from the light source unit (2), and emitting the light toward the colored portion (10); and a second light guide (30), receiving and guiding the reflected light, and emitting the light toward the color sensor (3) (a sixth configuration, FIG. 5).

Moreover, the configuration of any one of the first to sixth technical solutions may also be configured as, wherein the light source unit (2) and the color sensor (3) are mounted on a same substrate (4) (a seventh configuration, FIG. 1).

Moreover, the configuration of any one of the first to seventh technical solutions may also be configured as, wherein the moving direction is a rotational direction (R) (an eighth configuration, FIG. 1).

Moreover, the configuration of any one of the first to seventh technical solutions may also be configured as, wherein the moving direction is a linear moving direction (X) (a ninth configuration, FIG. 7).

Moreover, according to an aspect of the present disclosure, a position detection device (5) is configured to include: a light source unit (2), irradiating one or more colored portions (10) of a movable unit (1) that is movable along a moving direction (R); and a color sensor (3), receiving a reflected light reflected by the colored portion (10), and detecting a color component (a tenth configuration).

Moreover, a robot (7) according to an aspect of the present disclosure includes a joint portion on which the position detection device (5) of the configuration of any one of the first to tenth technical solutions is mounted (an eleventh configuration, FIG. 9).

Moreover, a machine (8) according to an aspect of the present disclosure includes: a dial (81); and the position detection device (5) of the configuration of any one of the first to eighth technical solutions, wherein the position detection device includes the movable unit (1) rotatable with the dial.

### INDUSTRIAL APPLICABILITY

The present disclosure is applicable to, for example, position detection of various objects.

1. A position detection device, comprising:
a movable unit, movable along a moving direction and including one or more colored portions;
a light source unit, irradiating the colored portion with a light; and
a color sensor, receiving a reflected light reflected by the colored portion, and detecting a color component.

2. The position detection device of claim 1, wherein
the movable unit includes the plurality of colored portions arranged along the moving direction,
the plurality of colored portions have different colors from each other, and
in a region of one of the plurality of colored portions, the colors are the same.

3. The position detection device of claim 2, wherein a region between adjacent two of the plurality of colored portions has a color different from any one of the colors of the plurality of colored portions, or has a space.

4. The position detection device of claim 1, wherein the colored portion has a gradation in which a color changes continuously along the moving direction.

5. The position detection device of claim 1, wherein the movable unit includes a single colored portion, and in a region of the colored portion, colors are the same.

6. The position detection device of claim 1, further comprising:
a first light guide, receiving and guiding the light emitted from the light source unit, and emitting the light toward the colored portion; and
a second light guide, receiving and guiding the reflected light, and emitting the light toward the color sensor.

7. The position detection device of claim 2, further comprising:
a first light guide, receiving and guiding the light emitted from the light source unit, and emitting the light toward the colored portion; and
a second light guide, receiving and guiding the reflected light, and emitting the light toward the color sensor.

8. The position detection device of claim 3, further comprising:
a first light guide, receiving and guiding the light emitted from the light source unit, and emitting the light toward the colored portion; and
a second light guide, receiving and guiding the reflected light, and emitting the light toward the color sensor.

9. The position detection device of claim 4, further comprising:
a first light guide, receiving and guiding the light emitted from the light source unit, and emitting the light toward the colored portion; and
a second light guide, receiving and guiding the reflected light, and emitting the light toward the color sensor.

10. The position detection device of claim 5, further comprising:
a first light guide, receiving and guiding the light emitted from the light source unit, and emitting the light toward the colored portion; and
a second light guide, receiving and guiding the reflected light, and emitting the light toward the color sensor.

11. The position detection device of claim 1, wherein the light source unit and the color sensor are mounted on a same substrate.

12. The position detection device of claim 2, wherein the light source unit and the color sensor are mounted on a same substrate.

13. The position detection device of claim 4, wherein the light source unit and the color sensor are mounted on a same substrate.

14. The position detection device of claim 5, wherein the light source unit and the color sensor are mounted on a same substrate.

15. The position detection device of claim 1, wherein the moving direction is a rotational direction.

16. The position detection device of claim 1, wherein the moving direction is a linear moving direction.

17. A position detection device, comprising:
a light source unit, irradiating one or more colored portions of a movable unit that is movable along a moving direction; and
a color sensor, receiving a reflected light reflected by the colored portion, and detecting a color component.

18. A robot, comprising a joint portion on which the position detection device of claim 1 is mounted.

19. A robot, comprising a joint portion on which the position detection device of claim 17 is mounted.

20. A machine, comprising:
a dial; and
the position detection device of claim 1, wherein the position detection device includes the movable unit rotatable with the dial.
